(19) United States
(12) Patent Application Publication
(10) Pub. No.: US 2020/0217011 A1
(43) Pub. Date: Jul. 9, 2020

(54) REINFORCED POLYMER CONCRETE AND METHOD FOR FABRICATING THE SAME

(71) Applicant: WEAV3D, Inc., Norcross, GA (US)

(72) Inventor: Christopher Oberste, Brookhaven, GA (US)

(21) Appl. No.: 16/821,600

(22) Filed: Mar. 17, 2020

Related U.S. Application Data
(63) Continuation-in-part of application No. 16/711,668, filed on Dec. 12, 2019.
Application No. 16/711,668 is a continuation-in-part of application No. 15/788,061, filed on Oct. 19, 2017.
Application No. 15/788,061 is a division of application No. 14/821,502, filed on Aug. 7, 2015, now Pat. No. 9,809,926.
Application No. 14/821,502 is a continuation-in-part of application No. 16/301,883, filed on Nov. 15, 2018.
(60) Provisional application No. 62/034,930, filed on Aug. 8, 2014.
(60) Provisional application No. 62/336,974, filed on May 16, 2016.

(51) Int. Cl. D06M 15/53; B29C 70/24; D03D 41/00; D03D 47/27

(52) U.S. Cl. CPC D06M 15/53; B29C 70/24; D03D 41/004; D10B 2505/02; D03D 41/00; D10B 2101/12; D03D 47/273

(57) ABSTRACT

Described herein is a reinforced polymer concrete composition that includes a polymer concrete cured while in contact with reinforcing material with a polymer that has a backbone containing cyclohexane dimethanol (“CHDM”). The polymer concrete can include an unsaturated polymer resin (“UPR”) as a binding agent. The reinforcing material and polymer concrete mixture can be brought in contact with each other prior to the polymer concrete curing. A cross-linking agent and a free radical initiator can be inserted for triggering a reaction between the CHDM-containing polymer and the UPR. The polymer can be a polyurethane or copolyester, such as polyethylene terephthalate glycol (“PETG”).

### CROSS-REFERENCE TO RELATED APPLICATIONS AND PRIORITY CLAIM

This application is a continuation-in-part of U.S. application Ser. No. 16/711,668, filed Dec. 12, 2019 (pending), which is a continuation in part of U.S. application Ser. No. 15/788,061, filed Oct. 19, 2017 (pending), which is a divisional application of U.S. Pat. No. 9,809,926, filed Aug. 7, 2015, which claims priority to U.S. Provisional Patent Application No. 62/034,930 filed Aug. 8, 2014. This application is also a continuation-in-part of U.S. application Ser. No. 16/301,883, which claims priority to International Application No. WO 2017/200935, filed May 15, 2017, which claims priority to U.S. Provisional Patent Application No. 62/336,974 filed May 16, 2016. The entire contents and substance of each of the above applications is hereby incorporated by reference in their entirety.

### BACKGROUND

Historically, concrete has been formed from a mixture that includes Portland cement and aggregate (often a mixture of fine and coarse aggregate). In order to improve the tensile strength and limit crack propagation, concrete is often reinforced with steel rebar or wire cage. Steel is selected for its low cost and workability, specifically that it can be hot formed and welded to achieve complex shapes; however, steel is subject to corrosion, which causes swelling of the steel and induces spalling and fracture in the concrete. The porosity of traditional concrete permits corrosive liquids and gases (such as salt water or hydrogen sulfide) to attack the steel rebar, which has led to numerous developments to mitigate this problem.

Composite rebar is commonly used as an alternative to steel rebar in construction applications with environmental constraints that make steel rebar unsuitable. This may include applications with high risk of corrosion (such as bridges, water treatment facilities, or industrial drainage) or sensitivity to magnetic interference (such as buildings that house magnetic resonance imaging equipment or radio broadcasting equipment). These materials are conventionally produced by pultrusion of fiber reinforced thermosets, though other production methods would be familiar to one having skill in the art. The majority of composite matrix materials are thermosets selected from the categories of unsaturated polyester resins, epoxy resins, vinylester resins, or acrylic resins. Fibers reinforcement is usually fiberglass, carbon fiber, or basalt fiber. The selection of fiber and matrix material is based on a combination of performance requirements, environmental requirements, and cost constraints.

Polymer concrete is defined to include both polymer cement concrete, whereby the polymer replaces lime-based cement used in traditional concrete, and polymer modified concrete, whereby the polymer is used in addition to lime-based cement. Polymer concretes are formed from a mixture that includes a polymer and aggregate. The most commonly used polymers are epoxy, latex, unsaturated polyester resin, vinylester, furan, and acrylate. Polymer concrete has several advantages compared to traditional concrete, including superior strength and impact resistance, low permeability, high chemical resistance, good vibration damping, and fast curing. The low permeability and high chemical resistance of polymer concrete make it particularly suitable for use in enclosures to protect sensitive electronic and control equipment and as well as drainage systems for industrial chemicals. Polymer concrete also protects steel rebar and wire cage from corrosion.

Failure of reinforced concrete frequently occurs due to shear slippage or disbond between the concrete and the reinforcement material which decouples the load transfer between the materials. Steel does not exhibit a high degree of adhesion to binders used in traditional concrete or polymer concrete. While coatings can be applied to steel to achieve adhesion, the preferred alternative involves texturing of rebar (deformed rebar) or using a wire cage structure, both methods that increases the load transfer area in contact with the concrete and resists shear slippage. Composite rebar used in traditional concretes often reproduce the texture or cage structure in an effort to replicate this effect; however very little optimization has occurred in the space of polymer concrete.

Polyesters are formed from the reaction of diacid and diol molecules. These can either be classified into unsaturated polyesters (which are thermoset materials) and saturated polyesters (usually thermoplastics) based on whether they retain double bonds after the polymerization process (unsaturated means that double bonds are retained). The presence of non-benzene double bonds allows unsaturated polyesters to be cross-linked into its final thermoset form.

Unsaturated polyester resin (“UPR”) may be used in the production of polymer concrete as the primary binding agent. The majority of UPR use a combination of maelic anyhydride and phthalic anhydride (diacids) plus propylene glycol (diol) to form the unsaturated polyester structure. The introduction of a cross-linking reagent (often styrene) and free radical initiator (often provided by methyl ethyl ketone peroxide (“MEKP”) or benzoyl peroxide (“BPO”)) triggers a reaction which opens the double bonds and allows the formation of cross-linking between adjacent polyester molecules through the styrene molecules. This cross-linking structure gives UPR good chemical resistance, which is why it is used in polymer concrete applications; however, UPR's adhesive properties are lower than epoxy (a more expensive thermoset), which makes selecting suitable reinforcement materials difficult.

Therefore, a need exists to identify a polymer material that would be compatible with UPR and serve as a reinforcement material.

### SUMMARY

Described herein is a composition and method of making a reinforced polymer concrete. The composition of the reinforced polymer concrete can include a polymer concrete mixture and a reinforcing material. The polymer concrete mixture can include UPR. In an example, UPR can be formed by combining maelic anhydride and phthalic anhydride (diacids) with propylene glycol (diol). The reinforcing material can include a polymer and a reinforcement fiber.

The polymer used in the reinforcing material can be any polymer with a backbone that includes cyclohexane dimethanol (“CHDM”). For example, the polymer can be a CHDM-containing polyurethane or polyester, such as PETG, polycyclohexylene dimethylene terephthalate glycol (“PCTG”), and polycyclohexylene dimethylene terephthalate acid (“PCTA”). The polymer can be thermoset or thermoplastic so long as it contains the CHDM backbone. The reinforcement fiber can be any type of fiber material that provides increased strength, stiffness, or functionality compared to the polymer. For example, the reinforcement fiber can be glass fiber, carbon fiber, basalt fiber, or metallic fiber.

In an example, the reinforced polymer concrete can be formed by inserting the polymer concrete mixture and the reinforcing material into a mold. The polymer concrete may be prepared by mixing UPR, aggregate, and a curing agent. The curing agent may consist of a cross-linking reagent and a free radical initiator. The reinforcing material may be added to the mold before the polymer concrete is introduced while still in a liquid or semi-liquid state. The interaction of the curing agent and UPR triggers a reaction in the UPR that opens double bonds and allows for cross-linking between adjacent polyester molecules through the cross-linking reagent molecules. In an example, the free radical initiator can be MEKP or BPO. The mixture may then be allowed to cure. In an example, the mixture may be cured at room temperature and pressure in an open mold that exposes at least part of the polymer concrete to the air. In another example, the mixture may be cured through the application of heat and/or pressure in a closed mold that fully encloses the polymer concrete during the curing process. In another example, the mixture may be cured in an open mold that is heated.

Described herein are also methods for creating an interlaced composite that includes a CHDM-containing polymer and introducing it into a polymer concrete mixture as a reinforcing material. An interlaced composite can be created and inserted into a mold. A polymer concrete mixture containing UPR, aggregate, and a curing agent can be inserted into the mold such that the polymer concrete mixture and CHDM-containing interlaced composite are in direct contact. The concrete mixture can then be allowed to cure.

Both the foregoing general description and the following detailed description are exemplary and explanatory only and are not restrictive of the examples, as claimed.

### BRIEF DESCRIPTION OF THE DRAWINGS

FIG. 1A illustrates a side view of a reinforced polymer concrete.

FIG. 1B illustrates a top view of a reinforced polymer concrete.

FIG. 2 illustrates lap shear test equipment loaded with a sample of reinforced polymer concrete.

FIG. 3 is a diagram of a plain weave illustrating the interlacing of warp and weft tapes in accordance with the present disclosure.

FIG. 4 illustrates an example method for incorporating an interlaced composite into a polymer concrete mixture as a reinforcing agent.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

### Materials Tested

Six thermoplastic materials were tested for adhesion to both open mold and closed mold polymer concrete mixes. Five of the selected plastics were chosen based on potential compatibility for bonding with unsaturated polyester used in polymer concrete, and one plastic (polypropylene) was selected as a known non-polar control. All plastics with potential compatibility contain polar carbonyl group (oxygen double bonded to carbon) and several possess rings structures within or attached to the main backbone chain. The selected polymers were chosen in an effort to approximate the molecular structure of the UPR and increase the likelihood of participating in the UPR cross-linking reaction caused by the presence of the curing agent. The tested thermoplastic materials were:

polypropylene (“PP”), which has repeated subunits of:

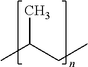

polyamide 6 (“nylon 6”), which has repeated subunits of:

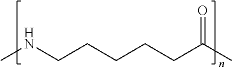

polyamide 6,6 (“nylon 6,6”), which has repeated subunits of:

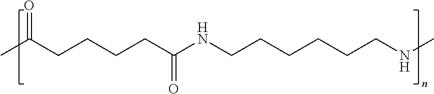

polyethylene terephthalate (“PET”), which has repeated subunits of:

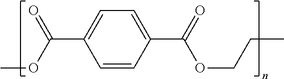

PETG, which is a copolymer of PET in which CHDM is added to the polymer backbone, but at lower levels than ethylene glycol (“EG”):

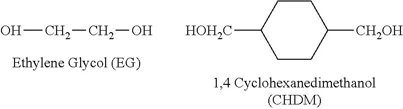

and polycarbonate (“PC”), which has repeated subunits of:

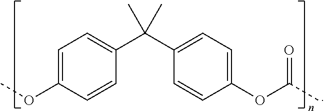

The diagram below illustrates an example polymerization process of PETG:

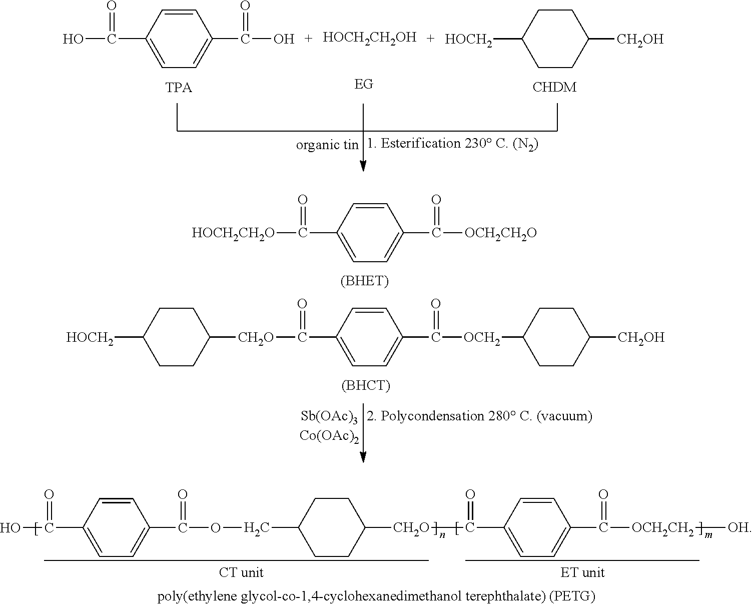

### Preparation

In order to investigate the adhesion between the candidate thermoplastic polymers and the UPR-based polymer concrete, a modified lap shear test was performed. In preparation for this test, rectangular strips of consistent size were cut for each of the candidate thermoplastic polymers. Where required, the strips were lightly sanded to increase roughness in order to achieve similar surface roughness between each material. In order to identify any potential influence of molding type on the adhesive behavior, strips of each material were prepared in both open mold and closed mold curing processes, where they were combined with polymer concrete, such that the thermoplastic strip is approximately flush with the surface of the polymer concrete. In the open mold process, the polymer concrete was cured at room temperature and pressure. In the closed molded process, the polymer concrete was cured at elevated temperature and pressure. The elevated temperature can range from 150 degrees centigrade up to the degradation temperature of the material, but it is typically closer to the 150 degrees centigrade. The pressure can range from a pressure greater than atmospheric pressure up to the compressive strength of the material, but it is typically elevated to 100-300 psi.

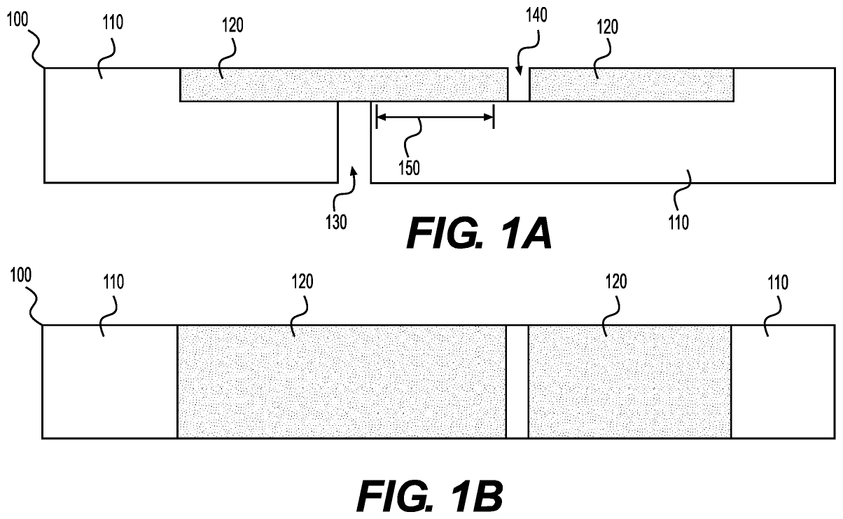

After the polymer concrete was permitted to fully cure (approximately 24 hours for closed mold processes and approximately 72 hours for open molded processes), test specimens were cut from the polymer concrete using a water jet. FIGS. 1A and 1B illustrate an example of a test specimen 100 after the water jet cuts. 120 identifies the thermoplastic strip and 110 identifies the polymer concrete. Notches 130 and 140 were created when the specimen was cut to create the necessary lap shear region 150.

### Testing

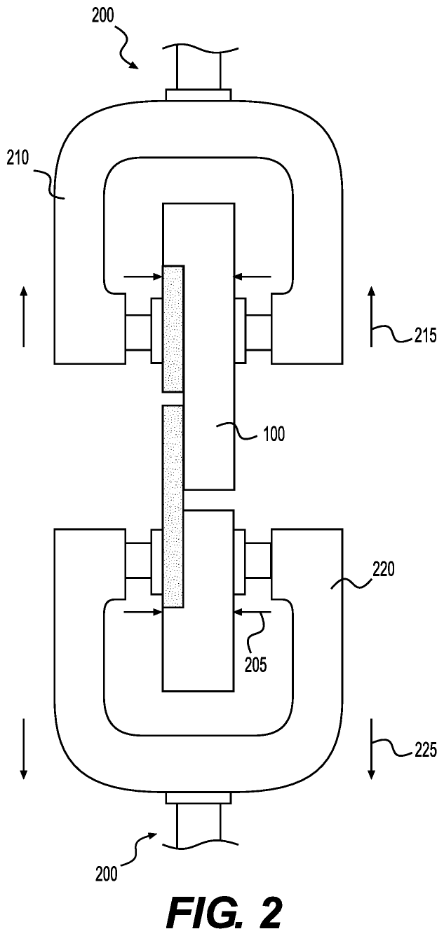

Test specimens prepared using the method described above can be tested using any type of universal testing machine with grips and load limit appropriate for the size of the specimen. FIG. 2 shows the test specimen 100 oriented within the grips of a universal testing machine 200, such that the length of the specimen is in-line with the tensile loading direction (illustrated by arrows 215) of the machine and the plane of the notches 130 and 140 are perpendicular to tensile loading direction. Grips 210 should be configured to provide sufficient force (illustrated by arrows 205) to firmly hold the test specimen 100 and avoid slippage, without applying so much force that it damages the test specimen 100 and induces failure at the grips.

The application of tensile load, through displacement of one of the grips 210 along the tensile loading direction, induces tensile strain in the test specimen 100. The notches 130 and 140 create a stress concentration region between them, which generates shear stress between the contact surface of the thermoplastic strip 120 and the polymer concrete 110. Adhesion between the thermoplastic strip 120 and the polymer concrete 110 can be determined by calculating the shear stress at the time of disbond failure. For thermoplastic materials with low adhesion, the shear strength will be less than the tensile strength of either of the constituent materials and disbond failure will occur. For thermoplastic materials with high adhesion, the adhesion strength may exceed the tensile strength of either the thermoplastic strip or the polymer concrete, resulting in a tensile failure in the weaker material.

In order to avoid biasing the test results due to inconsistent grip-induced prestress, the load cell was zeroed while the grips were open (without any test specimen) and a preload of 50N was specified for each specimen. The preload occurs after the specimen has been loaded in the grips, whereby the specimen is slowly loaded to 50N, at which point the displacement of the load cell is zeroed and the test is started.

### Results

### Polypropylene

The PP specimens were unable to survive the heated cure of the closed mold process. While they were able to survive the cure of the open mold process, the PP delaminated from the concrete during the waterjet cut described above. The bond strength of PP to the UPR concrete was therefore so weak that the adhesive shear strength could not be tested.

### Nylon 6,6

The Nylon 6,6 specimens were able to survive both the open and closed mold curing processes. However, similar to PP, none of the Nylon 6,6 samples survived the waterjet cutting. The bond strength of Nylon 6,6 to the UPR concrete was therefore too weak to be able to test the adhesive shear strength.

### Nylon 6

The Nylon 6 specimens also survived the curing processes. The closed mold Nylon 6 specimens failed the waterjet cutting process; however, the open mold samples survived. Of the four open mold Nylon 6 samples, two of them failed the 50N preload. The remaining two samples were tested and experienced failure in lap shear region 150 at loads between 100N and 275N. In other words, the Nylon 6 and polymer concrete separate from each other in the lap shear region 150 when the tensile load reached between 100N and 275N. Calculated adhesive shear strength for the two samples was 0.21 MPa and 0.47 MPa.

### Polycarbonate

The PC specimens did not survive the closed mold cure process, but all four open mold PC samples survived the open mold cure, waterjet cut, and 50N preload threshold. The PC samples exhibited a unique failure mode where the plastic sample initially disbonded at the edge of notch 130 opposite lap shear region 150 in FIG. 2A. This disbonding then propagated along the interface until it reached the grips of the testing machine. All four PC samples exhibited this failure mode and one sample also exhibited a subsequent failure at the lap shear region 150. After the load was removed, the thermoplastic strip 120 and polymer concrete 110 appeared to be in contact, but the disbond interface became visible if a small amount of tensile force was reapplied to the sample in its longitudinal direction. Due to the unusual failure mode, it was not possible to calculate adhesive shear strength; however, analysis of the force-displacement curve for the test showed that disbond initially occurs between 200N and 250N for two samples, between 400N and 425N for one sample, and around 800N for one sample.

### Polyethylene Terephthalate

Similar to the Nylon 6 samples, the PET specimens survived both the open and closed mold curing processes with the closed mold samples failing during the waterjet cut. Two of the four open mold PET samples also failed the 50N preload threshold. The remaining two specimens were tested and experienced failure in lap shear region 150 at loads between 150N and 250N. The calculated adhesive shear strength of the two specimens was 0.49MPa and 0.26 MPa.

### Polyethylene Terephthalate Glycol

The results for the PETG specimens were unexpected compared to all the other samples. Unlike every other sample tested, all the PETG specimens survived both the open and closed mold curing processes, the waterj et cut, and the 50N preload threshold. While the PETG exhibited some softening/compressive flow behavior during the closed mold cast and cure process, that did not weaken the material. To the contrary, it improved the interface with the polymer concrete as it provided a compliant surface to accommodate the polymer concrete mixture and increased the contact area between the two materials.

In all four of the open mold PETG specimens, the PETG itself fractured under a tensile load before any disbonding occurred in the lap shear region 150. The fracture consistently originated at the notch 130 (shown in FIG. 2) and then propagated through the thickness of the thermoplastic layer, leaving a hinge contact on the exposed face of the plastic strip. Two of the open molded PETG specimens fractured at loads between 575N and 625N, which is about three times greater load failure load observed for PET, despite the two materials coming from the same polymer family. One open molded PETG specimen failed between 300N and 350N and another failed between 500N and 550N. Furthermore, the failure mode observed was purely tensile, which indicates that the actual adhesive shear strength between PETG and the polymer concrete is even higher than what was observed for PC, despite the two materials failing under similar loads.

Two of the closed mold PETG specimens were tested. In both specimens, the polymer concrete fractured under tension at notch 140 (shown in FIG. 1) before any disbonding occurred in the lap shear region 150. The polymer concrete failure occurred at loads between 350N and 500N. Similar to the observation for open molded PETG, no adhesive shear strength can be calculated due to the tensile failure of the samples.

The polymer concrete likely failed before the PETG because the closed mold polymer concrete specimens were only ¾ inch thick, compared to the one-and-a-half-inch thick open mold samples. This difference in thickness, combined with the close mold mix having higher aggregate fraction, leads to more load concentrated in the polymer concrete. Due to this failure mode, it follows that the adhesion strength of the PETG-polymer concrete interface is higher than the tensile strength of the close mold polymer concrete mix. While the adhesion testing was conducted using unreinforced plastic strips, one of the claimed inventions involves utilizing a reinforcing material that contains both a polymer and a reinforcement fiber. The addition of a reinforcing fiber, particularly a continuous reinforcement fiber, would dramatically increase the tensile strength of the reinforcing material and change the failure mode to either polymer concrete failure or adhesive failure.

### Analysis

Polypropylene was selected to provide establish a benchmark for a material that we knew would not participate in the UPR polymerization reaction due to a lack of polarity and reactive functional groups. Nylon 6 and nylon 6,6 were expected to exhibit some polar interaction with the UPR; however, we were surprised to observe different behavior between these two materials as their chemical structures are very nearly identical. In particular, the observation that nylon 6,6 was no better than polypropylene at withstanding the waterjet cut, while the nylon 6 not only survived the waterjet cut, but also had 2/4 samples pass the 50N preload was unexpected.

Polycarbonate, PET, and PETG were expected to exhibit relatively similar adhesion behavior towards the UPR because their structures are based on backbone chains combining a ring structure, oxygen, and carbon, with carbonyl (double bonded oxygen) functionality. In particular, the closely related nature of PET and PETG led us to expect these materials to have very similar adhesive behavior and both materials were included only to provide us with cost flexibility and supplier alternatives. Despite this initial hypothesis, these three materials exhibited dramatically different adhesion behavior, with PET showing the worst adhesion, PC showing moderate adhesion, and PETG showing exceptional adhesion. The level of adhesion observed during tensile indicates that the PETG forms a chemical bond with the UPR in the polymer concrete.

Following the initial lap shear testing, the PC and PETG specimens were subject to sharp impact force to induce fracture in order to compare adhesive behavior between the materials. The PC materials suffered disbond at the interface between the plastic strip and polymer concrete regardless of whether they were struck on the plastic face or the polymer concrete face, or on edge near the interface. In the PETG samples, fracture paths were observed across the interface between the polymer concrete and PETG materials with no visual disbond, for both low angle and high angle fracture paths. This indicates that the adhesive strength between the materials is high enough to result in cohesive energy dissipation across the interface.

A final test, whereby a continuous glass fiber reinforced PETG sheet was cast into a UPR polymer concrete slab structure, cured, and then struck repeatedly with a hammer further confirmed the high level of adhesion between the polymer concrete and PETG. The glass/PETG sheet was sized to be smaller than slab and impact outside of sheet-reinforced region caused fracture within 1-2 strikes, while impact in the sheet reinforced region took 3-4 impacts before any fracture occurred and even once the surface layer of polymer concrete was cracked, several more impacts were necessary to propagate the impact through the sheet. Despite the fractures, the glass/PETG sheet remained firmly adhered to the polymer concrete fragments and it was only by pulling apart the glass strands within the glass/PETG tape that we were able to separate the fragments.

Terephthalic acid (“TPA”) and EG are common to both PET and PETG; however, PETG is unique in its inclusion of CHDM. Unlike TPA, which contains a benzene ring backbone, CHDM only has a cyclohexane ring (with carbon-carbon single bonds), which is both more flexible and more reactive than the benzene structure (due to benzenes delocalized resonate structure). Also, after polymerization, this cyclohexane ring is located further from the protective carbonyl functional groups, which makes it easier for the cyclohexane to participate in subsequent reactions.

The cyclohexane ring of CHDM may be participating in the free radical initiated cross-linking reaction that occurs when a curing agent is added to the liquid UPR during polymer concrete casting.

### The Embodiments

One embodiment of the reinforced polymer concrete described here can include polymer concrete and a reinforcing material. The reinforcing material can include a polymer and a reinforcement fiber. Based on a CHDM cross-linking reaction, the polymer in the reinforcement material can be any CHDM-containing polymer. The polymer can be thermoset or thermoplastic so long as it contains as CHDM backbone. For example, polyurethanes formed by reacting isocyanates and polyols can be synthesized using CHDM as part of the polyol component. It is suspected that all such CHDM-containing polyurethanes would experience similar bonding during the polymer concrete curing process. Some examples of CHDM-containing polyesters include the copolyesters PETG, PCTG, and PCTA. The monomers for polymerization of PCT, PCTG, and PCTA are:

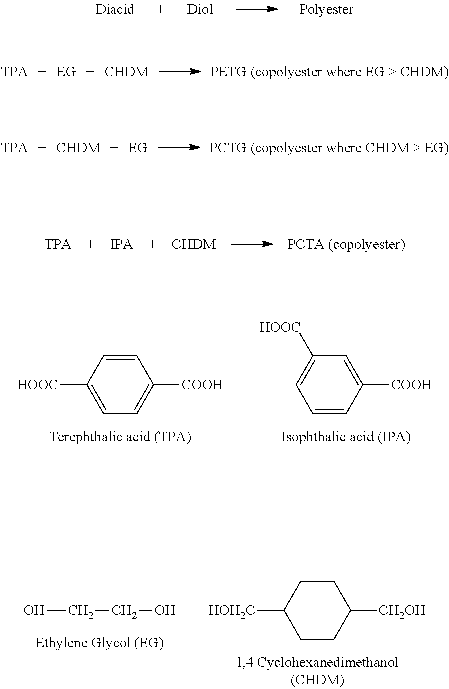

One example of a binding agent that can be used in the polymer concrete is UPR. Other binding agents can be used that would create the similar cross-linking mechanisms with CHDM-containing polymers, such as vinyl ester and epoxy. However, UPR is significantly cheaper and more widely available than the available alternatives. For that reason, it may be preferred to use UPR as the primary binding agent. UPR can be formed by combining maelic anhydride and phthalic anhydride (diacids) with propylene glycol (diol) to form an unsaturated polyester structure as shown below:

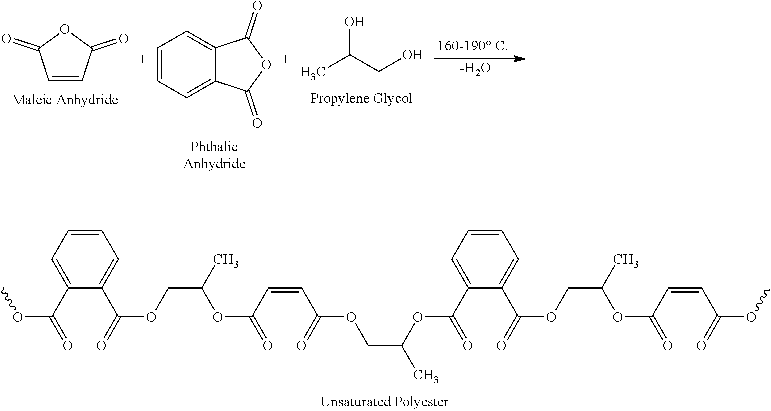

Polymer concrete differs from more traditional concretes in the binding agent used. Portland cement is the most common binding agent used in traditional concrete. When mixed with water, Portland cement creates a paste that binds with sand and rock to harden. While Portland cement usually originates from limestone, polymer concretes use polymers as a binding agent, as explained above. Because Portland cement-based concretes use a limestone-based binding agent as opposed to a polymer-based binding agent, their adhesion properties to different materials would greatly differ. For example, the paragraphs below describe a cross-linking mechanism that may be active in creating a chemical bond between CHDM-containing polyesters and UPR polymer concrete. This cross-linking mechanism would not be present with a Portland cement-based concrete and therefore would not experience the same adhesion strength with PETG.

Introducing a cross-linking reagent (such as styrene) and free radicals (often done by adding MEKP or BPO) triggers a reaction that opens the double bonds and allows the formation of cross-linking between adjacent polyester molecules through the styrene molecules. The chemical structure of this reaction is shown below:

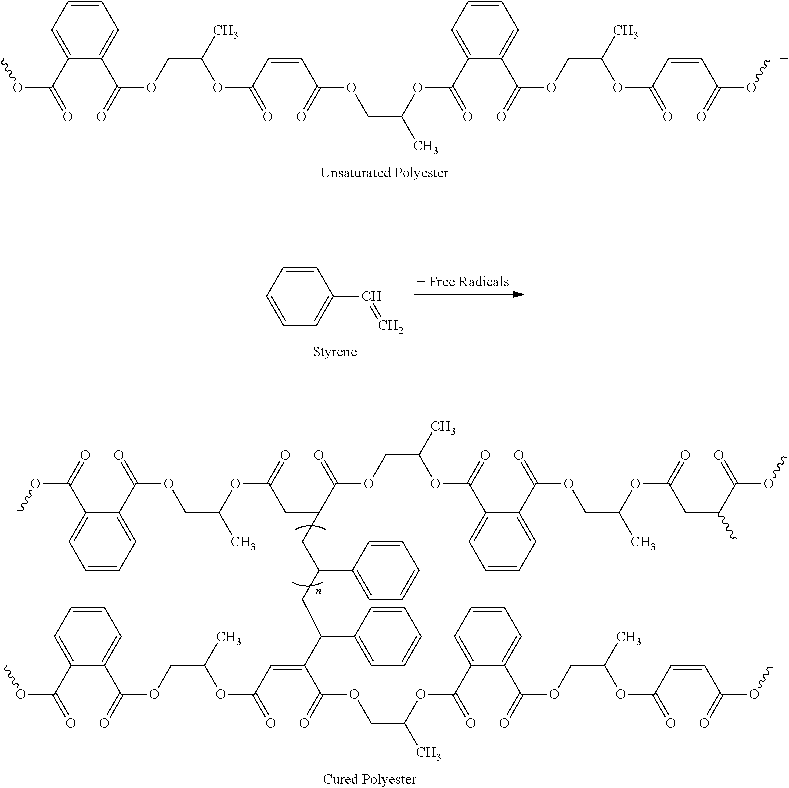

There are two possible cross-linking mechanisms that may be active in creating a chemical bond between CHDM-containing polyesters and UPR polymer concrete. First, as previously discussed, the cyclohexane ring of CHDM may participate in the free radical initiated cross-linking reaction that occurs when MEKP is added to liquid UPR during polymer concrete casting. Cyclohexane may be vulnerable to free radical initiated ring opening. As a result, it may be able to actively participate in the UPR cross-linking reaction as a radicalized UPR molecule or radicalized styrene attacks the CHDM, opening it and forming a bond with one arm of the open ring. After the ring opens, the remaining arm can rotate to a lower energy conformation (opposite the first arm) which may allow it to react with an additional styrene molecule without interference from the UPR attached to the first arm.

In another cross-linking mechanism, the cyclohexane within PETG may participate in the cross-linking reaction through radical substitution of one of the carbon-hydrogen bonds, rather than ring separation. Previous studies on this type of radical substitution reaction utilize phthalic acid-based CHDM-containing polyesters which changes the location of the cyclohexane ring relative to the protective carbonyl groups, whereas PETG both utilize terephthalic acid, so this mechanism may not be favored.

### EXAMPLE APPLICATIONS

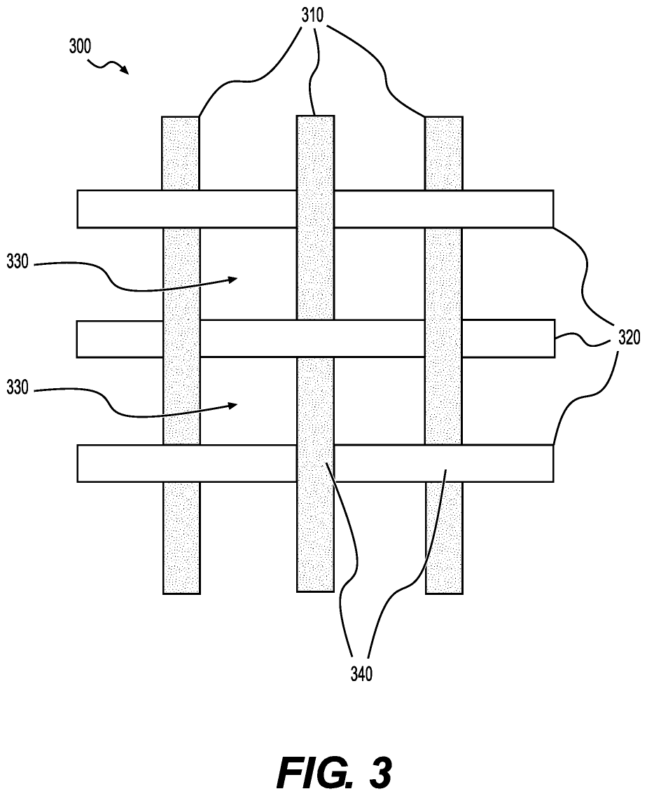

The unexpected results exhibited by PETG and polymer concrete using methods described herein can be advantageous when using an interlaced composite as a reinforcing structure in polymer concrete. FIG. 3 illustrates an exemplary embodiment of an interlaced composite 300 as described in related applications referenced above and incorporated by reference into this application. The interlaced composite 300 can include a first set of two or more warp tapes 310 (substantially parallel to one another) and a first set of two or more weft tapes 320 (substantially parallel to one another), wherein at least a portion of the first set of warp tapes 310 are interlaced with, and bonded and bonded to, at least a portion of the first set of weft tapes 320. As used herein, “tape” refers to an element having length much greater than its width or thickness. In the preferred embodiment, the tapes 310 and 320 can include a polymer and a reinforcement fiber, such as carbon, basalt, glass, metallic, or aramid, or any other fiber reinforcement that would be known by a person having ordinary skill in the art to provide increased strength, stiffness, or functionality compared to the polymer.

In an embodiment, one or more of tapes 310 and/or 320 can include a CHDM-containing polymer. In some embodiments it may be favorable to produce an interlaced component where all the tapes include a CHDM-containing polymer to maximize the adhesion of the polymer concrete to the interlaced composite. In other embodiments it may be favorable to design the interlaced composite where some number of tapes include a CHDM-containing polymer and other tapes include a non-CHDM-containing polymer that is still bondable to one or more tapes in the interlaced composite (PETG and PET would be one such example). This mixed material interlaced composite may be less expensive than a single material design, or it may be advantageous to induce disbond failure in some areas, while retaining a high level of adhesion in other areas to generate a pseudoplastic failure mode within the material.

As polymer concrete is traditionally poured or cast into a mold directly from a mixing device, it is important to ensure that the interlaced composite allows the polymer concrete to fill the mold without obstruction. Accordingly, warp tapes 310 and weft tapes 320 can be spaced apart so as to create openings 330. The interlaced composite can therefore be designed with one or more openings 330 to allow polymer concrete to flow through and around the interlaced composite during the molding process. In some embodiments, a plurality of openings 330 within the interlaced composite may be used to increase the surface area in contact between the interlaced composite and polymer concrete. In other embodiments, a plurality of openings 330 may generate a mechanical bond through encapsulation of interlace points 340 of the interlaced composites. Allowing polymer concrete to flow through and around the interlaced composite also has the benefit of reducing interfacial shear stress, caused by differential strain between materials, by creating continuity between the polymer concrete above and below the interlaced composite.

The use of an interlaced composite, as opposed to a unidirectional tape or extruded/pultruded rod provides additional benefits relating to the handling and location of lattice within the concrete component. Unidirectional tapes are difficult to handle and locate within the mold, due to their tendency to curl or twist, and are susceptible to movement during the pouring operation, which can result in a defective product. Extruded/pultruded composite rods, particularly those produced using from thermoset polymers, are well known within the construction industry to be labor intensive to install, as forming a reinforcing cage structure requires each rebar to be manually tied to each intersecting rebar. These tie points also represent areas of poor load transfer within the structure. The interlaced composite can be produced with tapes spaced as required by the structural design, and the use of thermoplastic polymers in the tapes permits the interlaced composite to be heat formed to any shape and also permits welding of the interlaced composite to itself and to other compatible thermoplastics (such as additional interlaced composites or thermoplastic anchors). The interlaced composite is also conducive to the production of prestressed concrete, as the lattice can be tensioned in the warp and weft directions prior to casting.

In some embodiments, a transmission material (such as optical fiber or metallic ribbon) may be utilized as a warp or weft tape within the interlaced composite. The inclusion of this transmission material may enable structural health monitoring of the cured concrete component. Having the transmission material embedded within the interlaced composite allows it to be precisely located in a known depth of the concrete component, which also happens to be the same location as the maximum expected tensile stress. Existing methods of placing optical fibers for structural health monitoring in concrete rely on manual placement of the material, which increases the likelihood of damaging the fiber or results in suboptimal placement caused by difficulty securing the fiber during the pouring process.

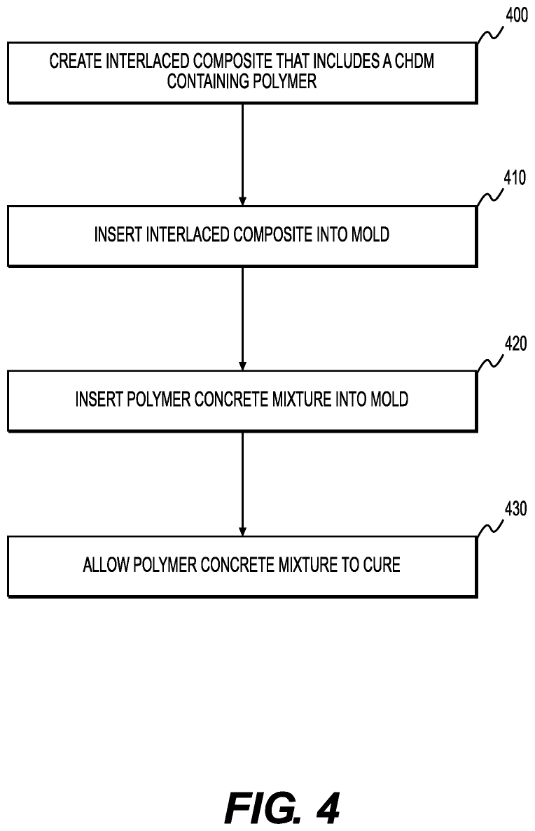

FIG. 4 illustrates an example method for incorporating an interlaced composite into a polymer concrete mixture as a reinforcing material. At stage 400, an interlaced composite can be created that includes a CHDM-containing polymer. As an example, the CHDM-containing polymer can be PETG. In an example, the interlaced composite can be created using the methods previously described herein, such as the method previously described regarding FIG. 3. The composition of the interlaced composite regarding where and how many CHDM-containing polymer tapes are used can be vary according to specific needs. For example, tapes with CHDM-containing polymer may be more expensive than those without, and so fewer tapes with the polymer can be used. In one example, the interlaced composite can have just one tape with the CHDM-containing polymer. In another example, all the tapes can have the CHDM-containing polymer. For reasons previously described herein, a greater number of tapes with a CHDM-containing polymer in the interlaced composite may create a stronger bond to polymer concrete.

At stage 410, the interlaced composite can be inserted into a mold. The mold can be open or closed. The interlaced composite can be positioned in the mold as desired, so long as at least a portion of the interlaced composite is in direct contact with any polymer concrete poured into the mold.

At stage 420, a polymer concrete mixture can be inserted into the mold. In an example, the polymer concrete mixture can be a concrete mixture that includes UPR as a binding agent. Examples of other binding agents can include epoxy and vinyl ester. It should be noted that stages 410 and 420 can be performed in the opposite order, simultaneously, or in an overlapping fashion. The polymer concrete mixture can include a cross-linking agent and a free radical initiator. Styrene is an example cross-linking agent that can be included. MEKP and BPO are example free radical initiators that can be included. For reasons described previously herein, the cross-linking agent and free radical initiator may open the molecules of the binding agent for bonding with the CHDM-containing polymer in the interlaced composite tapes.

In some examples, the interlaced composite and polymer concrete mixture can be inserted into the mold using a layering technique. For example, a portion of the mold can first be filled with polymer concrete mixture. An interlaced composite can then be pressed into the exposed surface of the polymer concrete mixture. Finally, additional polymer concrete mixture can be poured on top so that the interlaced composite is enclosed within polymer concrete mixture. In other examples, an interlaced composite can be inserted into the mold first. Polymer concrete mixture can then be poured into the mold, thus enclosing the interlaced composite.

At stage 430, the polymer concrete mixture can be allowed to cure. In an example where an open mold is used, the polymer concrete mixture can cure at room temperature and pressure. In another example where a closed mold is used, the polymer concrete mixture can be cured at an elevated temperature and pressure. For example, in a closed mold the polymer concrete mixture can cure where the temperature is above 150 degree centigrade and the pressure is between 100-300 psi.

Although numerous references herein are made to polymer concrete, it is contemplated that similar results can be expected when using UPR as a binding agent, or similar binding agents like vinyl ester and epoxy, in any thermoset mixture, introducing a curing agent to the mixture, and allowing the mixture to cure while in direct contact with a CDHM-containing polymer, such as PETG.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A composition comprising:
a polymer concrete mixture, the concrete mixture comprising an unsaturated polyester resin (“UPR”), aggregate, and curing agent; and
a reinforcing material comprising a polymer and a reinforcement fiber, wherein the polymer has a backbone comprising cyclohexane dimethanol (“CHDM”),
wherein the polymer concrete mixture is cured while in direct contact with the CHDM-containing polymer.

2. The composition of claim 1, wherein the polymer of the reinforcing material is a polyurethane.

3. The composition of claim 1, wherein the polymer of the reinforcing material is a copolyester.

4. The composition of claim 3, wherein the polymer of the reinforcing material is one selected from the group of: polyethylene terephthalate glycol (“PETG”), polycyclohexylene dimethylene terephthalate glycol (“PCTG”), and polycyclohexylene dimethylene terephthalate acid (“PCTA”).

5. The composition of claim 1, wherein the curing agent comprises a cross-linking reagent and free radical initiator.

6. The composition of claim 1, wherein the curing agent comprises a cross-linking reagent and free radical initiator.

7. The composition of claim 6, wherein the cross-linking reagent is styrene.

8. The composition of claim 6, wherein the free radical initiator is methyl ethyl ketone peroxide or benzoyle peroxide.

9. The composition of claim 1, wherein the UPR is created by combining maelic anyhydride and phthalic anhydride with propylene glycol.

10. The composition of claim 1, wherein the reinforcement fiber of the reinforcing material is one selected from the group of: carbon fiber, glass fiber, basalt fiber, and aramid fiber.

11. A composition comprising, a polymer concrete mixture, the concrete mixture comprising an unsaturated polyester resin (“UPR”), aggregate, and curing agent; and
an interlaced composite component comprising:
a first set of two or more warp tapes parallel to each other and separated from one another by a warp gap; and
a first set of two or more weft tapes parallel to each other and separated from one another by a weft gap;
wherein at least a portion of the warp tapes are interlaced with, and bonded to, at least a portion of the first set of weft tapes at locations of interlacing;
wherein the polymer concrete mixture is cured in contact with the interlaced composite component.

12. The composition of claim 11, wherein at least one of the warp tapes of the interlaced composite comprises a CHDM-containing polymer.

13. The composition of claim 11, wherein at least one the weft tape of the interlaced composite comprises a CHDM-containing polymer.

14. A method for manufacturing a reinforced concrete composition, comprising the steps of:
inserting a reinforcing material into a mold, wherein the reinforcing material comprises a polymer and a reinforcement fiber, and the polymer has a backbone comprising cyclohexane dimethanol (“CHDM”);
inserting a polymer concrete mixture into the mold, wherein the mixture comprises an unsaturated polyester resin (“UPR”), aggregate, and a curing agent; and
allowing the polymer concrete mixture to cure.

15. The method of claim 14, wherein the reinforcing material is an interlaced composite component.

16. The method of claim 15, wherein the interlaced composite component contains one or more openings to permit the polymer concrete mixture to flow through and around the interlaced composite component.

17. The method of claim 14, wherein the polymer of the reinforcement material is one selected from the group of: polyurethane and copolyester.

18. The method of claim 14, wherein the curing agent comprises a cross-linking reagent and free radical initiator.

19. The method of claim 14, wherein the polymer concrete is cured through the application of heat and pressure in a closed mold.

20. The method of claim 14, wherein the polymer concrete is cured at atmospheric pressure in an open mold.
